(19) United States
(12) Patent Application Publication
(10) Pub. No.: US 2002/0104844 A1
(43) Pub. Date: Aug. 8, 2002

(54) Paint bucket and ergonomic holder

(76) Inventor: Garrett A. Morelock, Bloomfield Hills, MI (US)

Correspondence Address: Theresa A. Orr, P.O. Box 828, Bloomfield Hills, MI, 48303, US

(21) Appl. No.: 09/776,819

(22) Filed: Feb. 5, 2001

(51) Int. Cl. B05C 21/00; B65D 25/10; B65D 53/00

(52) U.S. Cl. 220/570; 220/755

(57) ABSTRACT

The present invention includes a paint bucket preferably formed of a flexible material and having a set of rigid support arms extending opposite each other along the perimeter of the paint bucket. An ergonomic handle is provided for supporting the paint bucket. The ergonomic handle is preferably formed of a semi-circular, or horse shoe base, for surrounding a portion of the perimeter of the paint bucket. Slots are provided on either end of the base for receiving the rigid support arms provided along the outer perimeter of the flexible bucket. The bucket is easily removable and replaceable within the semi-circular base as desired by the user when using several different paint colors or when the bucket is empty. A support member extends outwardly from the base opposite the slots. The support member may include a gripper handle provided for swiveling the bucket into a usable position and maintaining that position by the user. A strap is provided with the support member for securing the support member along the forearm of the user.

### BACKGROUND OF THE INVENTION

1. Field of the Invention

The invention relates generally to an ergonomic brace for supporting a paint can assembly. More particularly, the invention relates to an ergonomically shaped brace for supporting a swivel paint can for a hands-free environment.

2. Discussion

Generally, professional and lay painters are required to carry a paint can around in one hand and paint brush in the other when painting trim and the like. Such arrangement has a tendency to cause fatigue and tension within the neck, arm and hand holding and carrying the paint can. Particularly, a user may experience muscle cramping and hand or finger tremor when continuous support of a paint can is required to perform such labor intensive work.

Previous inventions are directed toward, at best, alleviating such muscle tension and fatigue by providing an after-market handle for use with a standard paint can such as that taught by U.S. Pat. No. 5,570,807 issued to Gerald L. Busch on Nov. 5, 1996 and entitled “Apparatus and Method for Holding a Container in One Hand;” and U.S. Pat. No. Des. 409,912 issued to Robert D. Brennan on May 18, 1999 and entitled “Paint Can Handle.” A disadvantage of the finger sleeve taught by Busch and the handle taught by Brennan is that neither eliminates hand and arm fatigue. A further disadvantage of the finger sleeve is it is not sturdy enough to support long term use.

Other inventions are directed toward a hands-free paint can holder such as that taught by U.S. Pat. No. 6,006,966 issued to Carroll J. Voisin, Jr. on Dec. 28, 1999 and entitled “Paint Can Holder.” Voisin teaches a rigid holder for a standard paint can that attaches to a user's belt. Although such an arrangement provides a hands-free environment, a disadvantage of the handle is that it shows a use with a pre-existing paint can. Thus, because the handle is formed of a rigid non-adjustable material to support a full paint can, the handle requires additional adapters of different sizes to accommodate the different standard paint can sizes available in the marketplace. A further disadvantage of this arrangement is that the support for the paint can is dependent on the user having a belt line for supporting a belt. The belt then supports the handle about the user's waist. Such support is not durable enough to hold a full paint can in position about a user's waist where the belt itself may not be strong enough to maintain a paint can in a level position. The can may rotate about its central pivot point and spill the paint. Further, because the Voisin, Jr. handle uses an industry standard paint can, the handle must constructed of a material having sufficient rigidity to support the weight of a full paint can.

### SUMMARY OF THE INVENTION

Therefore, it is an object of the present invention to eliminate muscle tension and fatigue by providing a hands-free environment for painting.

It is another object of the present invention to provide an assembly including an ergonomic brace for supporting an object such as a flexible, light weight bucket.

It is another object of the present invention to provide a novel paint bucket.

It is still another object of the present invention to provide an ergonomic brace and bucket assembly that prevents the bucket from tipping over and spilling its contents.

It is still another object of the present invention to provide an ergonomic assembly that suspends a brace with bucket from a user's arm creating a light weight, tension free assembly that allows the bucket to swivel freely within the bracket.

The present invention includes a paint bucket preferably formed of a flexible material and having a set of rigid support arms extending opposite each other along the perimeter of the paint bucket. An ergonomic handle is provided for supporting the paint bucket.

The ergonomic handle is preferably formed of a semi-circular, or horse shoe base, for surrounding a portion of the perimeter of the paint bucket. Slots are provided on either end of the base for receiving the rigid support arms provided along the outer perimeter of the flexible bucket. Because the bucket is flexible, the sides may be squeezed inwardly to allow the bucket to be placed within the semi-circular base and secured by the rigid support arms within the slots provided. The base perimeter is preferably wider than the bucket outer perimeter and, along with the slots, allows the bucket to swivel freely due to gravity about the rigid support arms. The bucket is easily removable and replaceable within the semi-circular base as desired by the user when using several different paint colors or when the bucket is empty.

A support member extends outwardly from the base opposite the slots. The support member may include a gripper handle provided for swiveling the bucket into a usable position and maintaining that position by the user. A strap is provided with the support member for securing the support member along the forearm of the user.

### BRIEF DESCRIPTION OF THE DRAWINGS

FIG. 1 is side view of a preferred embodiment of the present invention in a use position;

FIG. 2 is an elevational view of a preferred embodiment of the present invention attached to a user and showing the bucket in a rotated position;

FIG. 3 is an elevational view of a preferred embodiment of the present invention; and

FIG. 4 is an exploded view of a preferred embodiment of the present invention.

### DETAILED DESCRIPTION OF THE PREFERRED EMBODIMENT

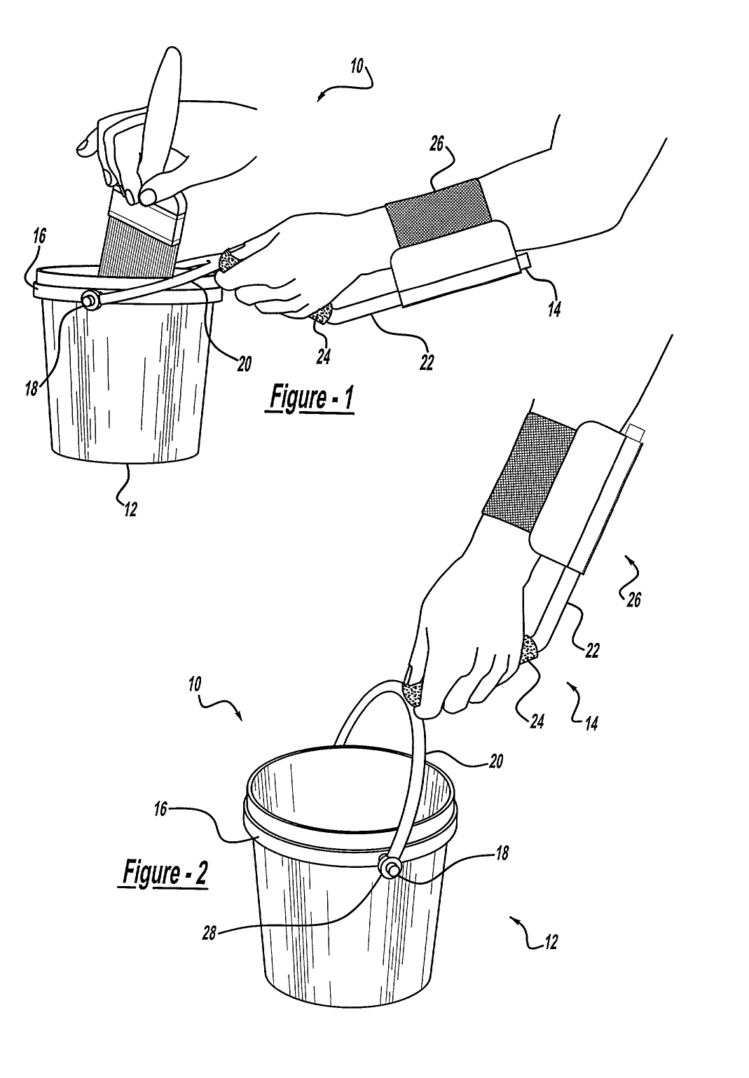

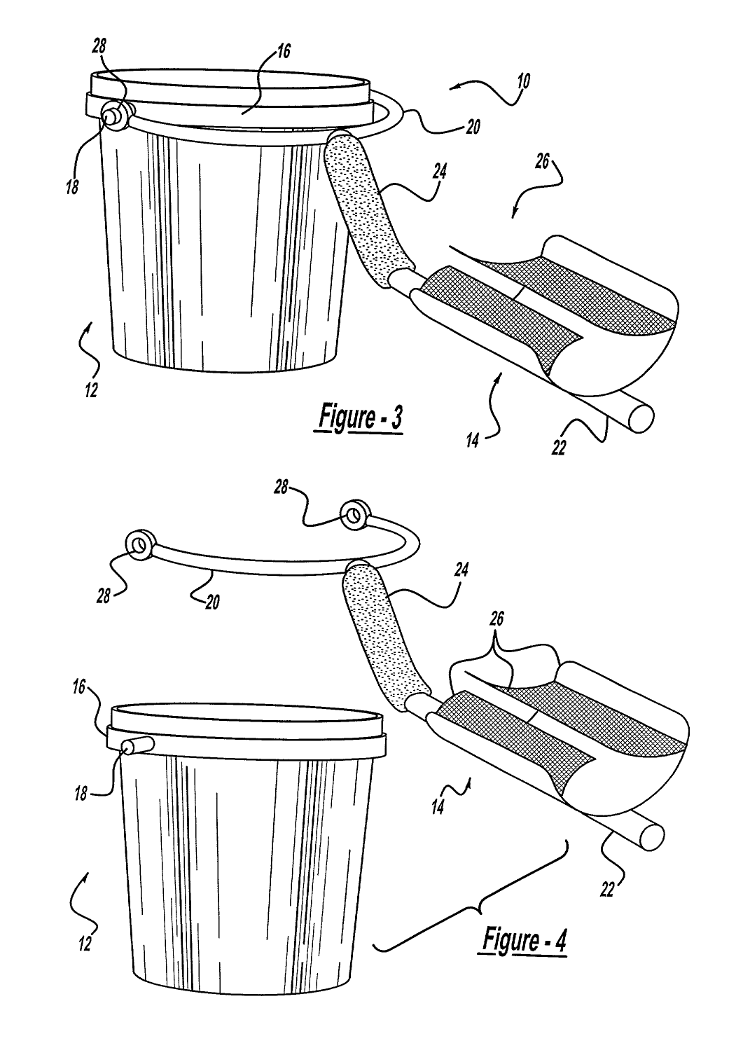

With reference to FIGS. 1-4, the preferred embodiments of the present invention are shown generally at 10. Specifically, FIG. 4 shows a preferred embodiment of paint bucket 12 and ergonomic brace 14. Paint bucket 12 is preferably formed of a flexible material and more specifically, has a flexible perimeter 16. A set of opposing rigid support arms 18 extend generally perpendicular to flexible perimeter 16.

Brace 14 is formed of rigid base member 20 that is preferably in a semi-circular shape for encompassing the flexible perimeter 16 of paint bucket 12. A support member 22 extends generally perpendicular to base 20 and is fixedly attached to base 20 opposite rigid base member 20. Support member 22 includes an angled grip 24 and strap 26 for fixing the ergonomic brace 14 to a user's forearm as shown in FIGS. 1 and 2. Slots 28 are provided at the ends of semi-circular rigid base member 20 for supporting an object such as paint bucket 12 having rigid support arms 18 as shown in FIG. 3.

In a preferred use of the present invention 10, flexible perimeter 16 of paint bucket 12 is flexed to slide rigid support arms 18 within slots 28. Ergonomic brace 14 is attached to a user's forearm with strap 26. Proper attachment is preferably shown in FIGS. 1 and 2, where support member 14 extends along the lower portion of the user's forearm and strap 26 extends around the upper portion of the user's forearm. Strap 26 may be of any configuration effective to support the ergonomic brace 14 with an object such as paint bucket 12. When placed on the user's forearm in this preferred arrangement, angled grip 24 may be held by the user's hand. Paint bucket 12 may be filled at any time during the assembly.

Once the paint bucket 12 is flexed into position within the ergonomic brace 14 and properly attached to a user's forearm, the paint bucket 12 may swivel freely within the semi-circular rigid support arms 18. With reference to FIG. 1, the grip 24 may be grasped by the user to swivel the paint bucket 12 upwardly to access the paint within the paint bucket 12. When the user has paint on his brush or is not in need of the paint bucket 12, the user may allow the paint bucket 12 to swivel downward and swing freely under gravity by allowing his forearm to hang naturally in a downward position as shown in FIG. 2. Thus, the ergonomic brace 14 supports the weight of the paint bucket 12 or any other object that may be attached to the base member 20 freeing the user's hands and resulting in a tension free, hands free work environment.

Paint bucket 12 is readily removable and replaceable from ergonomic brace 14 by simply flexing perimeter 16 inwardly to remove the rigid support arms 18 from slots 28. In this way, a user may have access to several different paint colors at one time by providing a supply of paint buckets 12. Alternatively, the paint bucket 12 is disposable or may be used as storage if desired.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

What is claimed is:

1. A paint bucket comprising:
a flexible perimeter; and
a set of rigid support arms extending opposite each other generally perpendicular to and outwardly from said perimeter.

2. The paint bucket of claim 1 and further comprising a handle for supporting said paint bucket at said rigid support arms, wherein said paint bucket is removable and replaceable within said handle by flexing said perimeter.

3. The paint bucket of claim 2, wherein said paint bucket is pivotable about said rigid support arms when supported by said handle.

4. The paint bucket of claim 1, wherein said paint bucket is disposable.

5. The handle of claim 2, further comprising:
A rigid base member extending around said perimeter between said rigid support arms;
A support member extending from said rigid base member opposite said rigid support arms; and
A strap attachable to said support member for securing said support member to a user.

6. An ergonomic brace for supporting a paint bucket comprising:
A rigid base member extending about the perimeter of said paint bucket;
A rigid support member fixedly attached to said rigid base member; and
A set of opposing support arms for removably securing said paint bucket to said rigid base member opposite said rigid support member.

7. The ergonomic brace of claim 6, further comprising a strap attachable to said support member for securing said support member to a user.

8. The ergonomic brace of claim 6, wherein said paint bucket is rotatably secured to said support arms and is able to swivel about said support arms within said rigid base member.

9. The paint bucket of claim 8, wherein said paint bucket is removable and replaceable within said rigid base member.

10. The paint bucket of claim 6, wherein said paint bucket is disposable.

11. The paint bucket of claim 6, wherein said paint bucket is formed of a flexible material.

12. A handle for use with a paint bucket, the handle and bucket assembly comprising:
A can comprising a flexible perimeter and a set of rigid support arms extending opposite each other and generally perpendicular to and outwardly from said perimeter;
A rigid base member extending around said perimeter between said rigid support arms;
A support member extending from said rigid base member opposite said rigid support arms; and
A strap attachable to said support member for securing said support member to a user.

13. The paint bucket of claim 12, wherein said paint bucket is removable and replaceable within said rigid base member of said handle by flexing said perimeter of said can.

14. The paint bucket of claim 13, wherein said can is rotatably secured to said support arms and is able to swivel about said support arms within said rigid base member.

15. The paint bucket of claim 14, wherein said can is disposable.

16. The handle of claim 12, wherein said support member is removably attached to a user by said strap and supports said handle and bucket assembly ergonomically about a user's arm for hands—free support of said can within said rigid base member.
